(19) United States
(12) Patent Application Publication
(10) Pub. No.: US 2010/0189415 A1
(43) Pub. Date: Jul. 29, 2010

(54) RECORDING MEDIUM REPRODUCING DEVICE AND REPRODUCING METHOD

(75) Inventor: Kenji Ohsawa, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/160,924

(22) PCT Filed: Jan. 16, 2007
(86) PCT No.: PCT/JP2007/050473

§ 371 Date: Jul. 15, 2008

(30) Foreign Application Priority Data
Jan. 20, 2006 (JP) 2006-012098

(51) Int. Cl. H04N 5/91

(52) U.S. Cl. 386/95; 386/E05.003

(57) ABSTRACT

[Problems] An object of the present invention is to perform switching of audio and subtitle and so on automatically or by simple operation when a recording medium such as a DVD, on which a plurality of streams of audio and subtitle are recorded, is reproduced.

[Means for Solving Problems] A playback pattern based on combination of streams of video, audio, and subtitle which was reproduced in the past is stored in a flash memory 12. Then, a microcontroller 10 makes an audio/video/subtitle processing section 7 reproduce a playback pattern based on combination of the streams different from the playback pattern stored in the flash memory 12.

### TECHNICAL FILED

The present invention relates to a reproducing device for reproducing a recording medium such as an optical disk, on which a video stream, an audio stream and a subtitle stream are recorded, and a reproducing method thereof.

### BACKGROUND

In a recoding media such as a DVD (Digital Versatile Disc), contents of movie are converted into digital signals, and the digital signals are recorded as a video stream, an audio stream, a subtitle stream and so on. Furthermore, in a reproducing device of DVD, a video stream, an audio stream corresponding to the video stream and a subtitle stream are synchronized by information installed in a disk or apparatus, and reproduced.

### DISCLOSURE OF THE INVENTION

### Problem to be Solved by the Invention

For example, when each audio stream and video stream have both Japanese language and English in contents of movie, a predetermined audio and subtitle are reproduced unless a user displays a menu screen and performs a changing action. For this reason, while the user watches the movie over and over again, the user lacks in freshness and gets tired with the operation.

Consequently, an object of the present invention is to provide a recording medium reproducing device and a reproducing method thereof. The recording medium reproducing device can switch audio or subtitle automatically or by simple operation when the recording medium such as a DVD, on which a plurality of audio streams and subtitle streams are recorded, is reproduced.

### Means for Solving Problem

According to a first aspect of the present invention, recording medium reproducing device having a recording medium on which a plurality of streams is recorded and a reproducing device for reproducing the recording medium with a playback pattern combining the plurality of streams includes a storage device for storing the playback pattern reproduced by the reproducing device, and a controlling device to make the reproducing device reproduce the recording medium with the playback pattern different from the playback pattern stored in the storage device.

According to a second aspect of the present invention, A reproducing method for reproducing the recording medium, on which a plurality of streams is recorded, with a playback pattern combining the plurality of streams comprising the steps of: storing the reproduced playback pattern, and reproducing the recoding medium with the playback pattern different from the stored playback pattern.

### BRIEF DESCRIPTION OF THE DRAWINGS

FIG. 1 is a block diagram showing a DVD player according to first and second embodiments of the present invention.

FIGS. 2A to 2E illustrate data structure recorded in a DVD.

FIG. 3 is a flowchart showing a changing operation of a play pattern according to the first embodiment of the DVD player shown in FIG. 1.

FIG. 4 is a flowchart a changing operation of a play pattern according to the second embodiment of the DVD player shown in FIG. 1.

### EXPLANATION OF REFERENCE SIGN

1 DVD player (recording medium reproducing device)

7 Audio/video/subtitle processing section (reproducing device)

10 Microcontroller (controlling device)

12 Flash memory (storage device)

13 DVD (recording medium)

S5 reproduce with combination different from playback history (reproducing device)

S8 update the playback history (storage device)

S11 update the playback history (storage device)

S5′ reproduce with combination of streams which are not reproduced

### BEST MODE FOR CARRYING OUT THE INVENTION

A first embodiment of a recording medium reproducing device of the present invention is explained below. In the recording medium reproducing device, a playback pattern which was reproduced is stored in a storage device, and the a controlling device makes a reproducing device reproduce a recording medium with a playback pattern different from the stored playback pattern. By the above, the recording medium is reproduced by a playback pattern different from the playback pattern which was reproduced before. Thereby, a user can see the recording medium in a different way even if the user plays again and again.

At least two types of a video stream, an audio stream, and a subtitle stream as the streams is recorded on the recording medium, and at least one of the two types of the streams may be recorded more than once. Thereby, since there is a plurality of playback patterns, the recording medium can be reproduced by the playback pattern different from the playback pattern reproduced once.

Furthermore, the controlling device may let the reproducing device reproduce a playback pattern according to combination different from combination of streams stored in the storage device as the reproduced combination. As a result, the playback pattern of combination different from the combination of streams reproduced once is reproduced. Therefore, a user can watch a recording medium in a different way although the user plays more than once.

Also, the controlling device may make the reproducing device reproduce a playback pattern of combination of streams except the combination stored in the storage device as the reproduced combination. Thereby, the streams which are never reproduced can be reproduced preferentially. Therefore, user can watch all of contents of the recording medium early and effectively.

A reproducing method of a recording medium of an embodiment of the present invention includes the steps of: storing a playback pattern which was reproduced; and reproducing the playback pattern different from the stored playback pattern. By the above, the recording medium is reproduced with the playback pattern different from the playback pattern which was reproduced once. Therefore, user can see the recording medium in a different way even if the user plays back the recording medium repeatedly.

### Example 1

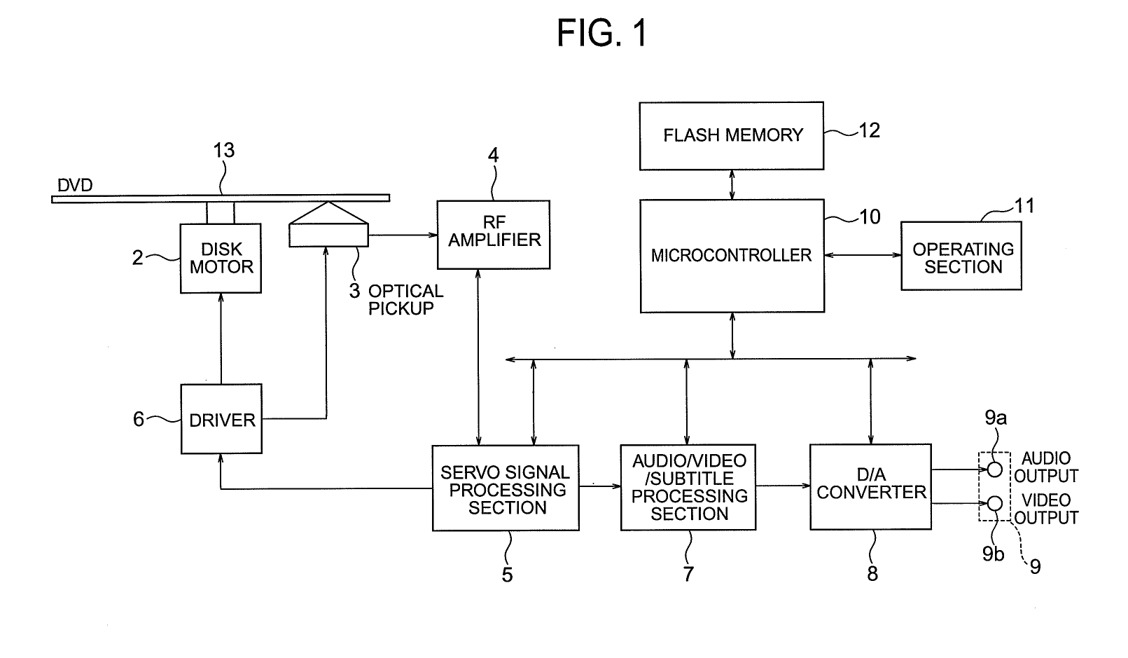

A DVD player 1 as a recording medium reproducing device according to a first embodiment of the present invention is explained by referring to FIGS. 1 to 7. The DVD player 1 is a playable device for reproducing a DVD and a CD (Compact Disc) as a recording medium. As shown in FIG. 1, the DVD player 1 includes a disk motor 2, an optical pickup 3, a RF amplifier 4, a servo signal processing section 5, a driver 6, a audio/video/subtitle signal processing section 7, a D/A converter 8, an audio/video signal output terminals 9, a microcomputer 10, a microcontroller 10, an operating section 11 and a flash memory 12.

The disk motor 2 is configured by such as a spindle motor for rotating a DVD 13 mounted on the DVD player 1.

The optical pickup 3 includes respective laser diodes having CD and DVD wavelengths not-shown laser oscillators for generating light beams applied to the DVD 13, an objective lens for applying the laser beam from the laser diodes to the DVD 13, an actuator driving the objective lens so as to focus and track according to indication from the servo signal processing section 5, and a optical receiver for receiving the light beam reflected from the DVD 13. The optical receiver converts the reflected light beam received into photoelectron. Electric signal converted into photoelectron is outputted as a RF signal including the streams of audio/video/subtitle read from the DVD 13 in the optical pickup 3 or signals for servo-controlling.

The RF amplifier 4 amplifies the signal outputted from the optical pickup 3 to a predetermined value, and outputs to the servo signal processing section 5.

The servo signal processing section 5 makes the optical pickup 3 drive based on a signal for servo-controlling focusing and tracking inputted from the RF amplifier 4, and controls the focusing and the tracking to allow data recorded on the DVD 13 to be read correctly. Further, the servo signal processing section 5 converts a RF signal including the streams of video, audio and subtitle recorded on the DVD 13 from analog to digital, and outputs to the audio/video/subtitle signal processing section 7.

The driver 6 amplifies the signal inputted from servo signal processing section 5, and outputs to the disk motor 2 and the optical pickup 3.

The audio/video/subtitle signal section 7 as a reproducing device corrects errors of the video stream, the audio stream and the subtitle stream inputted from the servo signal processing section 5. Then, the audio/video/subtitle signal section 7 decodes the streams of the video, audio and subtitle to a video signal, an audio signal or a subtitle signal. Then, the video and the subtitle signals are combined, and outputted to the D/A converter 8.

The D/A converter 8 converts the digital signal inputted from the audio/video/subtitle signal processing section 7 into an analog signal, and outputs via a audio output terminal 9a and a video output terminal 9b.

The microcontroller 10 as a controlling device is built into CPU (Central Processing Unit), RAM (Random Access Memory), and ROM (Read only Memory). The microcontroller 10 totally controls operations, for example, installing, ejecting, playing and stopping of a disk, in the DVD player 1, and decides a playback pattern of disk so as to reproduce.

The operating section 11 includes a button for operating playback and stop of the DVD player 1, and a display device for displaying a button which can switch the playback pattern at one-button and operating condition.

The flash memory 12 as a storage device is a nonvolatile memory element, and stores a title of the DVD 13, playback history of the playback pattern of respective titles and so on.

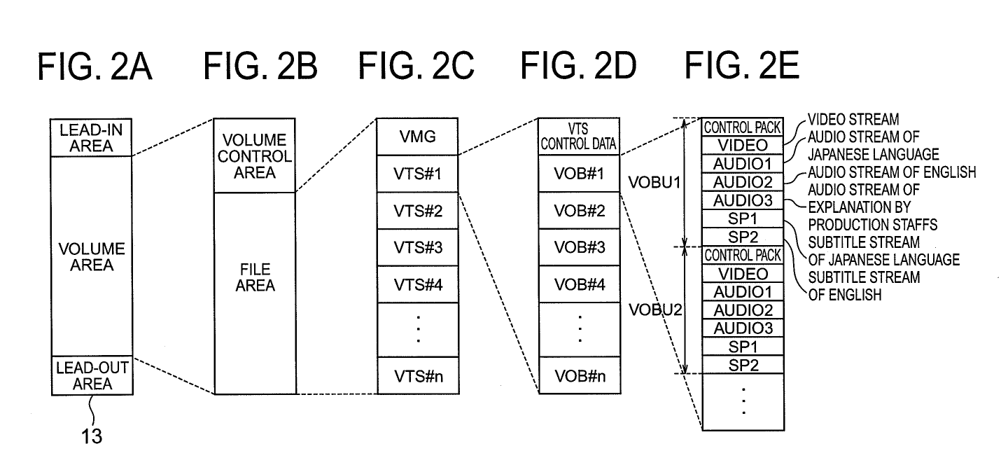

Next, data structure recorded on the DVD 13 is explained with reference to FIGS. 2. In FIGS. 2, streams of one video, three audio and two subtitles are recorded. As shown in FIG. 2A, the DVD 13 is configured with a lead-in area, a volume area and a lead-out area. In the lead-in area, data showing the DVD and DVD types (for example, DVD-ROM, DVD-R, DVD-RW and DVD-RAM etc.) are recorded. Contents such as a movie are recorded on the volume area. Data showing end of a recording area is recorded on the lead-out area.

As shown in FIG. 2B, the volume area is configured with a volume control area and a file area. The volume control area records control data according to file system of UDF (Universal Disk Format). The file area records contents of movie and control data of the contents.

As shown in FIG. 2C, the file area is configured with a video manager (here after, VMG) and a video title set (here after, VTS). The VMG records data for controlling the VTS of entire disk. For example, data such as a system menu, playback sequence of the VTS, title data, a plurality of audio streams, and a sub-picture stream are recorded on the VMG. The sub-picture is data for superimposing words of a song on video. In embodiments of the present invention, the sub-picture is data of subtitle. The VTS can be divided into arbitrary number from 1 to 99, and records the streams of video, audio, subtitle, and data for controlling the each VTS.

As shown in FIG. 2D, the VTS is configured with a VTS control data and a video object (here after, VOB). In the VTS control data, data for performing playback control of a plurality of VOB is recorded. The VOB records the video stream, the audio stream, subtitle stream and so on.

As shown in FIG. 2E, the VOB is configured with a plurality of VOB unit (here after, VOBU). The VOBU is configured with a control pack, a video stream (shown in Video of FIG. 2E), an audio stream (shown in Audio of FIG. 2E) and a subtitle stream (shown in SP of FIG. 2E). Control data of each VOBU is recorded on the control pack. In the Video shown in FIG. 2E, video streams of a predetermined time, which is called GOP (Group Of Picture), are recorded. The Audio 1 to 3 records audio streams which should be reproduced with each GOP time, and the SP 1, 2 record subtitle streams which should be reproduced with each GOP time. In this embodiment, the Audio 1 is an audio stream of Japanese language, the Audio 2 is an audio stream of English, and the Audio 3 is an audio stream of explanation by production staffs. Further, the SP 1 is a subtitle stream of Japanese language, and the SP 2 is a subtitle stream of English. That is, in the structure mentioned above, at least two types of video, audio and subtitle streams are recorded. Also, one of the two types is recorded more than once.

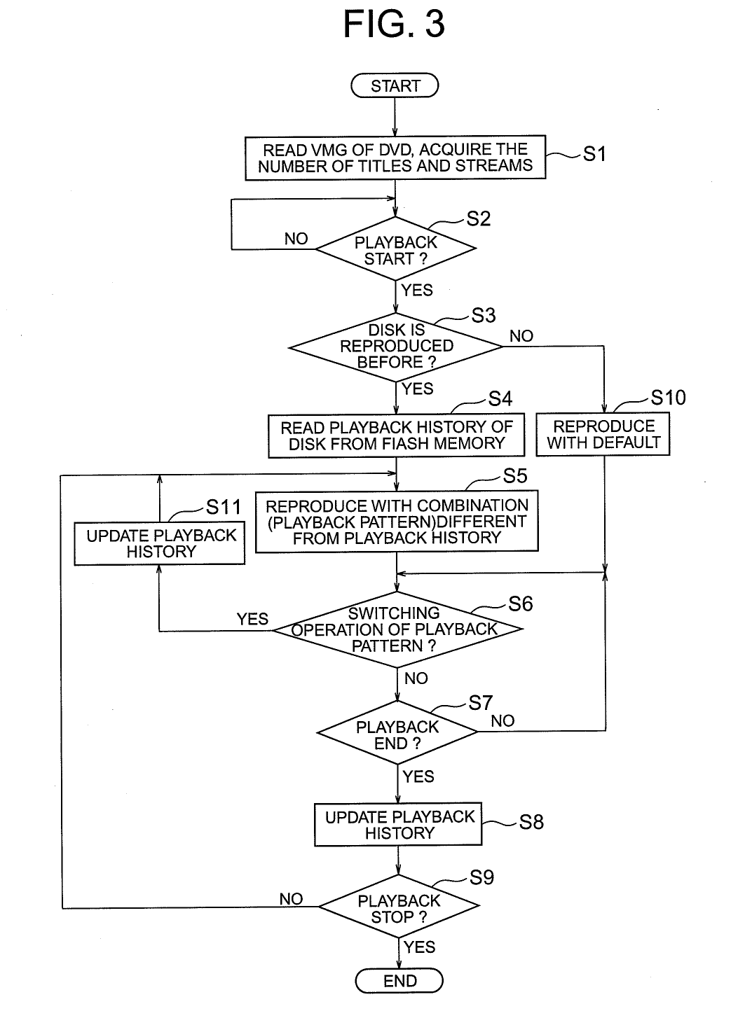

In the DVD player 1 configured as FIG. 1, an operation, in case that the playback pattern of the DVD 13 configured as FIGS. 2 is switched, is explained by referring to a flowchart shown in FIG. 3. The flowchart shown in FIG. 3 is performed by executing a control program stored in the ROM of the microcontroller with CPU of the microcontroller 10.

In this embodiment, the playback pattern is combination of the streams. For example, there is a combination of the video stream, the audio stream of English and the subtitle stream of Japanese language from combinations of various streams (e.g. the video stream, the audio streams of Japanese language, English, and explanation by production staffs, the subtitle streams of Japanese language, English).

First, in step S1, after applying laser beam to the DVD 13, VMG area of the DVD 13 is read to RAM of the microcontroller 10 via the optical pickup 3, the RF amplifier 4, the servo signal processing section 5, and the audio/video/subtitle signal processing section 7. And then, the number of title and streams of video and audio are acquired. Thereafter, the process goes to step S2.

Next, in step S2, it is judged whether or not user carries out an operation of playback start at the operating section 11. When the operation of playback start is performed, a signal of playback start is inputted to the microcontroller 10 from the operating section 11. Therefore, it is judged whether there is the signal or not. When there is the signal (the judgment is YES, that is, playback start), the processing goes to step S3. On the other hand, when there is not the signal (the judgment is NO, that is, not start), it is judged again.

Next, in step S3, it is judged whether or not a title, which was read at step S1, was reproduced before. In particular, it is judged whether or not a title read in RAM corresponds with a title recorded on the flash memory 12. When there is the title of the RAM corresponding to the title of the flash memory 12, that is, when there is a disk reproduced before, the processing goes to step S4. However, when there is not the title of the RAM corresponding to the title of the flash memory 12, that is, when there is a disk which is not reproduced before, the processing goes to step S10. In other words, when the judgment is YES, the processing goes to step S4. On the other hand, when the judgment is NO, the processing goes to step S10.

Next, in step S4, the disk is judged as the disk reproduced in the past, and playback history of this disk in flash memory 12 is read to the RAM of the microcontroller 10. Then, the processing goes to step S5.

Next, in step S5 as the reproducing device, the reproducing device refers to the loaded playback history, and chooses a playback pattern of combination of video, audio and subtitle from combination of video, audio and subtitle which are not recorded in the playback history. Then, the reproducing device orders playback start to the audio/video/subtitle processing section 7. Thereafter, the processing goes to step S6. For example, when the combination of the video stream, the audio stream of Japanese language, and English subtitle is chosen, the reproducing device instructs the audio/video/subtitle processing section 7 to choose the Video, the Audio 1 and the SP2 of the VOBU shown in FIG. 2E and reproduce. That is, the playback pattern of the combination different from the combination recorded as a reproduced combination is reproduced.

As a method of selection, for example, tables of all combinations of streams of the video, the audio, and the subtitle are created in the RAM. And then, the combination of streams, that is, the playback pattern is selected from the tables in a random manner. Thereafter, the playback pattern is compared with the playback history. When the playback pattern is not recorded in the playback history, the playback pattern is reproduced. On the other hand, when the playback pattern is recorded in the playback history, the playback pattern is selected from the tables again. Alternatively, after the playback pattern stored in the playback history is deleted from the tables of all combinations, the playback pattern may be selected in a random manner. Furthermore, the playback pattern may be selected in order from first table or arbitrary table. Additionally, the audio stream and the subtitle stream may be selected in a random manner or in order without the tables of the combinations of the streams. When the selected playback pattern, that is, the selected combination is not recorded in the playback history, the selected playback pattern may be reproduced.

When playback starts, streams read as a reflected light beam with the optical pickup 3 from the DVD 13 are converted into electric signal. Then, this electric signal is amplified to a predetermined value with the RF amplifier 4, and is converted into analog-to-digital in the servo signal processing section 5. And then, the converted signal including streams of video, audio, and subtitle are separated and decoded by the audio/video/subtitle processing section 7. Thereafter, the streams of audio, video, and subtitle according to the playback pattern are reproduced selectively, and the video and the subtitle are combined. Then, the combined video and subtitle, and the audio are inputted to the D/A converter 8. In the D/A convert 8, the audio signal, and video signal combining the subtitle are converted into digital-to--analog. Then, the converted signal output via the audio output terminal 9a and the video output terminal 9b.

Next, in step S6, it is judged whether or not an operation of switching of the playback pattern is performed with the operating section 11. When the operation of switching of the playback pattern is performed, a signal of switching of the playback pattern is inputted from the operating section 11 to the microcontroller 10. Thereby, it is judged whether or not there is the signal. When the switching of the playback pattern is performed (that is, the judgment is YES), the processing goes to step 11. On the other hand, when the switching of the playback pattern is not performed (that is, the judgment is NO), the processing goes to step S7.

In step S7, it is judged whether or not the disk to the end is reproduced, or whether or not the playback is finished by the operating section 11. When the playback is finished (YES), the processing goes to step S8. On the other hand, when the playback is not finished (NO), the processing returns to step S6.

In step S8 as a storage device, the playback pattern which was reproduced is added to the playback history, and is stored in the RAM of the microcontroller 10. Furthermore, history of the disk of the flash memory 12 is updated. Then, the processing goes to step S9.

Next, in step S9, it is judged whether or not an operation of playback stop is performed by the operating section 11. When the operation of the playback stop is performed, a signal of the playback stop is inputted to the microcontroller 10. Thereby, it is judged whether there is a signal or not. When the playback is stopped (the judgment is YES), the processing goes to the end. On the other hand, when the playback is not stopped (the judgment is NO), the processing returns to step S5.

In step S10, the disk is judged as the disk which is not reproduced, and is reproduced with the playback pattern which is installed by default of this disk or the DVD player 1. Then, the processing goes to step S6.

In step S11 as a storage device, it is judged that an operation of switching of the playback pattern was performed. As a result, the playback pattern which was reproduced in added to the playback history, and is stored in the RAM of the microcontroller 10. Also, history of the disk of the flash memory 12 is updated. Then, the processing returns to step S5.

According to the embodiment of the present invention, for example, when there is one video, and a plurality of audio and subtitles, there is a plurality of combinations of audio and subtitles. In this case, the reproducing device of the present invention makes the flash memory 12 store history of the playback pattern of the past. Then, by playing to the end or by performing one-touch operation, the reproducing device can play back with the other combination which is not stored in the flash memory 12 by automatic operation or simple operation.

Therefore, user can watch a recording medium in a different way even if the user plays back more than once.

### Example 2

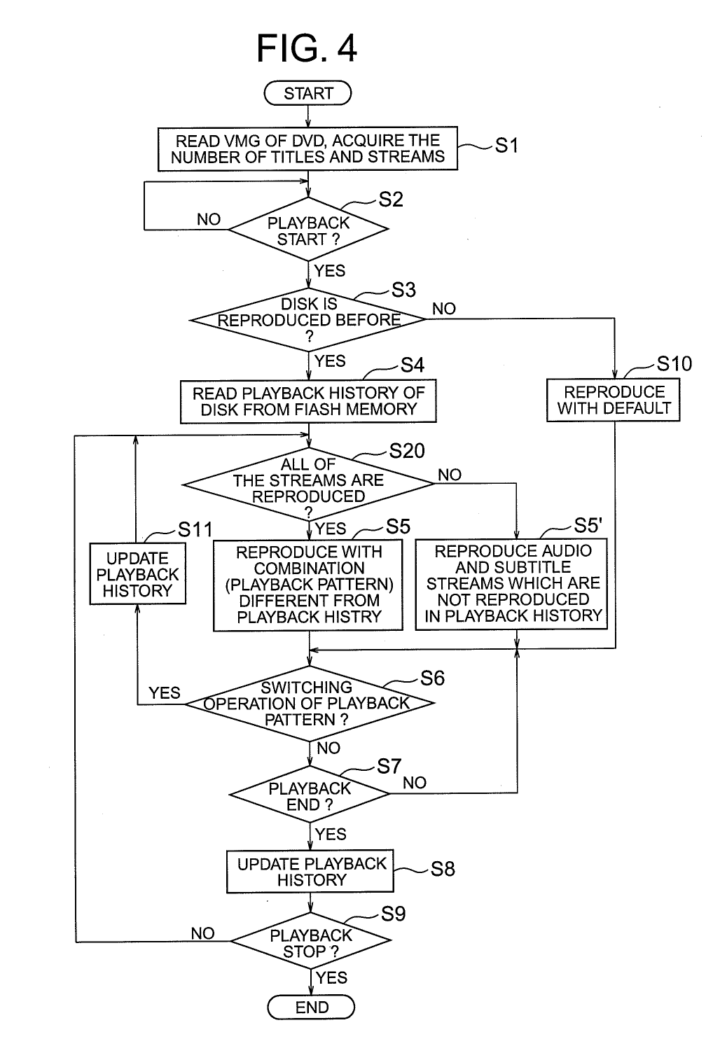

The DVD player 1 as the recording device of the recording medium according to a second embodiment of the present invention is explained with reference to FIG. 4. Incidentally, for some elements same with those of the first embodiment, same reference numerals are used and explanations are omitted.

The structure according to this embodiment is substantially same as that of the first embodiment, however, in the second embodiment, an operation of switching the playback pattern is different from the first embodiment. FIG. 4 shows the operation of switching the playback pattern. More specifically, after the playback history is read from the flash memory 12 (step S4), it is judged whether or not all of the streams were reproduced (step S20). When the entire streams are not reproduced, the combination of streams which is not reproduced is reproduced (step S5′).

In step S20, it is judged whether or not audio streams of Japanese language, English, and explanation by production staffs, and subtitle streams of Japanese language and English which are recorded on the DVD 13 everything are reproduced one or more times. When all of the streams are reproduced (that is, the judgment is YES), the processing goes to step S5. On the other hand, when the total streams are not reproduced (that is, the judgment is NO), the processing goes to step S5′. In this embodiment, since only one video stream is recorded in the DVD 13, the video stream is excluded from the judgment at this step S20.

In step S5′ as the reproducing device, the reproducing device checks the playback history, chooses the stream which is not reproduced from the streams of audio and subtitle, and plays back in combination with video stream. For example, when the video stream, the audio stream of Japanese language, and the subtitle stream are reproduced, the audio is chosen from the audio streams of English or explanation by production staffs, and reproduced. Also, in the subtitle, the subtitle stream of Japanese language is chosen and reproduced. That is, the playback pattern of the combination of streams excluding the streams reproduced is reproduced.

According to the embodiment of the present invention, for example, when there is one video, and a plurality of audio and subtitles, there is a plurality of combinations of audio and subtitles. In this case, the history of the playback pattern of the past is stored in the flash memory 12. Then, by playing to the end or by performing one-touch operation, the playback pattern of the combination of the streams which are not stored in the flash memory 12 is reproduced with automatic operation or easy operation. Therefore, user can see and hear by different ways even if the user plays repeatedly. Furthermore, the user can watch quickly all of contents recorded on the disk so that the streams which are not reproduced are reproduced by priority.

In above embodiments, the playback pattern only chooses patterns which are not reproduced. However, rarely-needed patterns such as combination of Japanese language audio and Japanese language subtitle can be omitted from the predetermined playback pattern, and the playback pattern can be chosen from the predetermined playback pattern in which patterns which are not used almost are excluded.

Furthermore, the above embodiments are explained with the DVD recording streams of three types (audio, video, and subtitle) as the playback pattern. However, the present invention is not limited to there three types. A DVD recording streams of four types or more can be used, and a DVD recording streams of two types, (for example, either the audio stream or the subtitle, and video stream) can be applied. Additionally, in the DVD recording streams of three types, the combination of pattern which does not reproduce either the audio stream or the subtitle stream can be included in the playback pattern.

In the above embodiments, the video stream is one type, however, the present invention is not limited to one type. The present invention can use a DVD having a plurality of video streams such as multi angle.

Furthermore, according to the above embodiments, the video stream is a moving image, however, can be a still image.

In addition, it is possible to apply contents, which are able to play back by switching streams such as a plurality of video, audio, and subtitles, to a reproducing device of recordable media such as a Blu-ray Disc, a HD-DVD (High-Definition Digital Versatile Disc), and a HDD recorder (Hard Disk Drive recorder).

The embodiments described above provide the reproducing device of the recording medium and the method of reproducing.

[Appendix 1]: A DVD player 1 having a DVD 13, on which a plurality of streams is recorded, and an audio/video/subtitle processing section 7 for reproducing the DVD 13 with playback pattern combining the plurality of the streams includes a flash memory 12 storing the playback pattern which was reproduced by the audio/video/subtitle processing section 7, and a microcontroller 10 to make the audio/video/subtitle processing section 7 reproduce the DVD 13 with the playback pattern different from the playback pattern stored in the flash memory 12.

According to the DVD player 1, the playback pattern different from the playback pattern reproduced before is reproduced. Therefore, user can watch the DVD in a different way even if the user plays the DVD repeatedly.

[Appendix 2]: A DVD reproducing method for reproducing a DVD 13, on which a plurality of streams is recorded, with a playback pattern combining the plurality of the streams includes steps of: storing the playback pattern which was reproduced, and playing the DVD 13 with the playback pattern different from the playback pattern stored.

According to the reproducing method of the DVD, the playback pattern different from the playback pattern reproduced in the past is reproduced. Therefore, user can watch the DVD in a different way even if the user plays the DVD more than once.

The embodiments of the present invention are only exemplary and not limited thereto. Any modification and alteration are within the scope of the present invention.

1. A recording medium reproducing device having a recording medium on which a plurality of streams is recorded and a reproducing device for reproducing the recording medium with a playback pattern combining the plurality of streams comprising:
a storage device for storing the playback pattern reproduced by the reproducing device; and
a controlling device to make the reproducing device reproduce the recording medium with the playback pattern different from the playback pattern stored in the storage device.

2. The recording medium reproducing device as claimed in claim 1,
wherein at least two types of a video stream, a audio stream, and a subtitle stream as the streams are recorded on the recording medium, and at least one of the two types of the streams is recorded more than once.

3. The recording medium reproducing device as claimed in claim 1,
wherein the controlling device makes the reproducing device reproduce a playback pattern based on combination of the streams different from combination of the plurality of streams stored in the storage device as the reproduced combination.

4. The recording medium reproducing device as claimed in claim 1,
wherein the controlling device makes the reproducing device reproduce a playback pattern based on combination of the streams except the streams stored in the storage device as the reproduced combination.

5. The recording medium reproducing device as claimed in claim 2,
A reproducing method for reproducing the recording medium, on which a plurality of streams is recorded, with a playback pattern combining the plurality of streams comprising the steps of:
storing the reproduced playback pattern; and
reproducing the recoding medium with the playback pattern different from the stored playback pattern.
